(19) United States
(12) Patent Application Publication
(10) Pub. No.: US 2024/0046499 A1
(43) Pub. Date: Feb. 8, 2024

(54) DEVICE, SYSTEM, AND METHOD FOR CAUSING ELECTRONIC ACTIONS FOR CATEGORIES OF PERSONS-OF-INTEREST

(71) Applicant: MOTOROLA SOLUTIONS, INC., Chicago, IL (US)

(72) Inventors: Kai Boon KHOO, BAYAN LEPAS (MY); Seng Huan CHUAH, BAYAN LEPAS (MY); Chin Seng TAN, BAYAN LEPAS (MY); Nur Syahirah Syafinaz MOHD YUSOFF, BAYAN LEPAS (MY)

(21) Appl. No.: 17/879,300

(22) Filed: Aug. 2, 2022

(51) Int. Cl. G06T 7/70; G06V 20/52

(52) U.S. Cl. CPC G06T 7/70; G06V 20/52; G06T 2207/30196; G06T 2207/10016

(57) ABSTRACT

A device, system, and method for causing electronic actions for categories of persons-of-interest (POI) is provided. A device maintains an attendee list of persons located within a given area using images received from cameras monitoring the given area. In response to determining that the given area meets a given condition the device: uses a current version of the attendee list to generate a POI list of POIs within the given area; categorizes, using the images received from the cameras, the POIs into given categories based on: whether a POI is being monitored by the cameras; whether a location associated with the POI is determined; and, the location associated with the POI, when determined; and causes one or more respective electronic actions to occur in relation to respective POIs associated with a given category into which the respective POIs are categorized.

### BACKGROUND OF THE INVENTION

During some public-safety incidents, persons in given areas, and the like, may be in danger, and first responders generally need to prioritize resources depending on where the persons may be located. However, determining such information can be challenging and furthermore determining electronic actions to implement to respond to an incident may be challenging.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system for causing electronic actions for categories of persons-of-interest, in accordance with some examples.

FIG. 2 is a device diagram showing a device structure of a communication device for causing electronic actions for categories of persons-of-interest, in accordance with some examples.

FIG. 3 is a flowchart of a method for causing electronic actions for categories of persons-of-interest, in accordance with some examples.

FIG. 4 depicts aspects of a method for causing electronic actions for categories of persons-of-interest being implemented by a computing device of the system of FIG. 1, in accordance with some examples.

FIG. 5 depicts further aspects of a method for causing electronic actions for categories of persons-of-interest being implemented by a computing device of the system of FIG. 1, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

During some public-safety incidents, persons in given areas, such as buildings and the like, may be in danger, and first responders generally need to prioritize resources depending on where the persons may be located. However, determining such information can be challenging and furthermore determining electronic actions to implement to respond to an incident may be challenging. Thus, there exists a need for an improved technical method, device, and system for causing electronic actions for categories of persons-of-interest.

Hence, provided herein is a device, system, and method for causing electronic actions for categories of persons-of-interest. In particular, an incident may occur at a monitored given area, such as a building (e.g., a school, an office, and the like) where persons-of-interest (POIs) associated with the given areas are registered via a computing device. Registration data may include, but is not limited to, storing images of the POIs along with emergency contact information, such as communication addresses and/or phone numbers of relatives, and the like. Using a school as an example, students and teachers, as well as visitors, may register with the school, and an incident may occur that is associated with the school, and which may be inside or outside the school. Such an incident may include, but is not limited to, a fire being observed or reported, a fire alarm being pulled, a person with a weapon being observed or reported, etc.

The given area is understood to be monitored via cameras in communication with the computing device. In particular one or more cameras may be monitoring access points of the given area such that persons inside the given area may be determined, for example by comparing images of persons entering and exiting the access points, as acquired by the cameras, with images of the registration data. The persons inside the given area may be maintained as an attendee list by the computing device. When the given area meets a given condition, such as an incident occurring, the computing device uses a current version of the attendee list to generate a POI list of POIs within the given area. Again using a school as an example, the POI list may represent persons inside the school when the incident occurs.

The computing device continues to receive images from the cameras to determine whether POIs on the POI list are being monitored by the cameras, for example to determine whether respective POIs on the POI list are in images from the cameras, or not in images from the cameras. For POIs that are in images from the cameras, the computing device may determine respective locations and/or predicted respective locations, of the POIs. From the images, the computing device may categorize the POIs on the POI list based on whether they are being monitored by the cameras and/or based on associated locations of the POIs (e.g., when such associated locations are determined).

Such categories may include, but are not limited to: for POIs not being monitored by the cameras, a highest risk category; for POIs being monitored by the cameras and located in a designated intermediate risk location (e.g., still inside the given area, and in some potential danger from the incident), an intermediate risk category; and, for POIs being monitored by the cameras and located in a designated lowest risk location (e.g., which may be inside or outside the given area, and/or not in danger from the incident) a lowest risk category. Designated risk of locations may be determined heuristically and/or via machine learning algorithms, and the like.

The computing device generally causes one or more respective electronic actions to occur in relation to respective POIs associated with a given category, into which the respective POIs are categorized.

For example, highest risk electronic actions may include, but are not limited to: triggering an electronic search and rescue protocol; initiating one or more calls to one or more communication devices associated with communication addresses registered in association with the portion of the POIs (e.g., in the registration data); connecting one or more public-safety answering point (PSAP) calls from one or more registered communication addresses, associated with the portion of the POIs, to one or more communication devices associated with one or more first responders; providing information collected during one or more public-safety answering point (PSAP) calls, from one or more registered communication addresses, associated with the portion of the POIs, to one or more communication devices associated with one or more first responders; and the like.

For example, intermediate risk electronic actions may include, but are not limited to: triggering an evacuation protocol; transmitting one or more messages to one or more communication devices associated with communication addresses registered in association with the portion of the POIs (e.g., in the registration data); providing POI registration data to one or more communication devices associated with one or more first responders; and the like.

For example, lowest risk electronic actions may include, but are not limited to: transmitting one or more messages to one or more communication devices associated with communication addresses registered in association with the portion of the POIs (e.g., in the registration data); and the like.

An aspect of the present specification provides a device comprising: a communication interface configured to communicate with cameras monitoring a given area; and; a controller configured to: maintain an attendee list of persons located within the given area using images received from the cameras via the communication interface; in response to determining that the given area meets a given condition: use a current version of the attendee list to generate a person-of-interest (POI) list of POIs within the given area; categorize, using the images received from the cameras, the POIs into given categories based on: whether a POI is being monitored by the cameras; whether a location associated with the POI is determined; and, the location associated with the POI, when determined; and cause, via the communication interface, one or more respective electronic actions to occur in relation to respective POIs associated with a given category, into which the respective POIs are categorized.

Another aspect of the present specification provides a method comprising: maintaining, via a computing device, an attendee list of persons located within a given area using images received from cameras monitoring the given area; in response to determining, via the computing device, that the given area meets a given condition: using, via the computing device, a current version of the attendee list to generate a POI list of POIs within the given area; categorizing, via the computing device, using the images received from the cameras, the POIs into given categories based on: whether a POI is being monitored by the cameras; whether a location associated with the POI is determined; and, the location associated with the POI, when determined; and causing, via the computing device, one or more respective electronic actions to occur in relation to respective POIs associated with a given category, into which the respective POIs are categorized.

Each of the above-mentioned aspects will be discussed in more detail below, starting with example system and device architectures of the system in which the embodiments may be practiced, followed by an illustration of processing blocks for achieving an improved technical method, device, and system for causing electronic actions for categories of persons-of-interest.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the drawings.

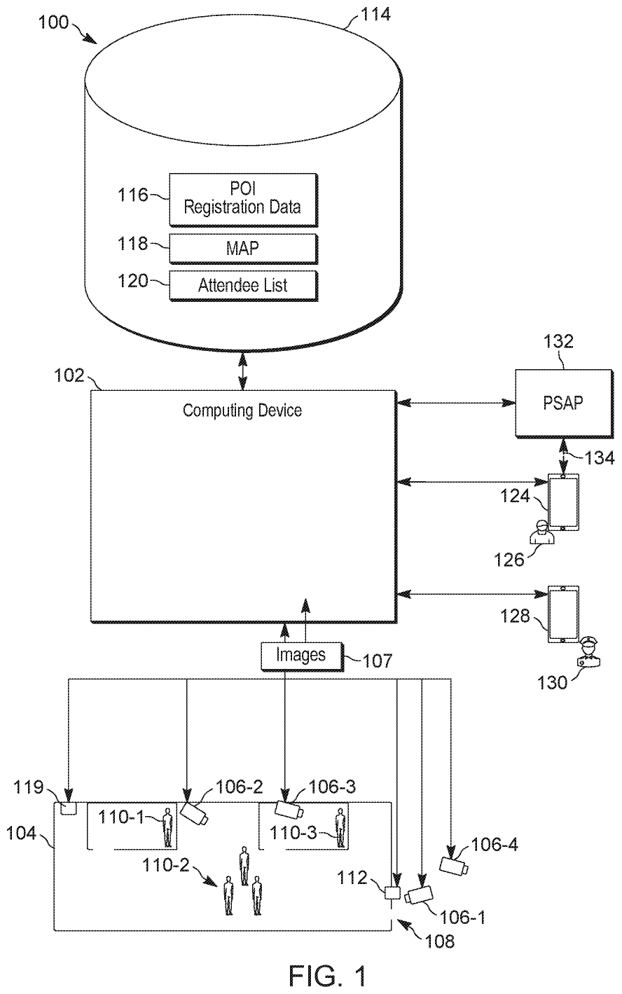

Attention is directed to FIG. 1, which depicts an example system 100 for causing electronic actions for categories of persons-of-interest. The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like.

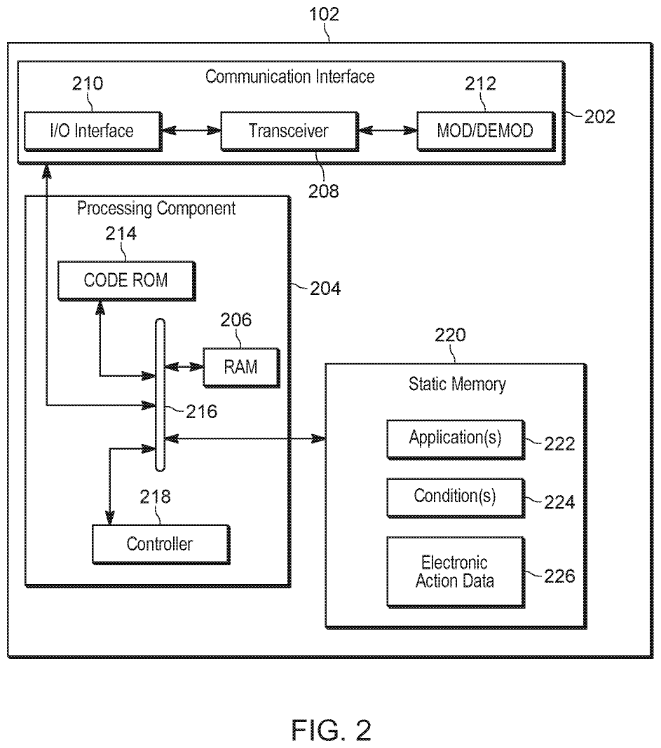

The system 100 comprises a computing device 102 associated with a given area 104. The computing device 102 is interchangeably referred to hereafter as the device 102. The device 102 may be located on or off the premises of the given area 104 and may comprise a server and/or a cloud computing device, and/or any suitable computing device in any suitable format. In some examples, functionality of the device 102 may be distributed over a plurality of servers, a plurality of cloud computing devices and the like. Details of the device 102 are described in more detail below with respect to FIG. 2.

The given area 104 may comprise any suitable building, such as a school, an office, and the like. As depicted, the system 100 includes one or more cameras 106-1, 106-2, 106-3, 106-4 in communication with the device 102. The one or more cameras 106-1, 106-2, 106-3, 106-4 are interchangeably referred to hereafter, collectively, as the cameras 106 and, generically, as a camera 106; this convention will be used throughput the present specification. The cameras 106 are generally configured to acquire images 107, and provide the images 107 to the device 102.

While four cameras 106 are depicted, the system 100 may comprise fewer than four cameras 106, or more than four cameras 106.

At least a portion of the cameras 106 are located to monitor the given area 104. For example, the camera 106-1 is located to monitor an access point 108 to the given area 104, such as a door, and the like, of the given area 104, such that the camera 106-1 acquires images 107 of persons 110-2, 110-3, 110-3 (e.g., the persons 110 and/or a person 110) entering and exiting the given area 104 via the access point 108; such images 107 may be received by the device 102 to maintain an attendee list of persons 110 located in the given area 104, as described in more detail below. While only one camera 106-1 is located at the access point 108, more than one camera 106 (e.g., pointing at and away from the access point 108) may be located at the access point 108 (e.g., inside or outside the access point 108) to acquire images 107 of persons 110 entering and exiting the given area 104 via the access point 108.

As depicted, a card reader 112 (e.g., a radio frequency identifier (RFID) card reader), and the like, is located at the access point 108, and is in communication with the device 102; registered persons 110 may be issued cards that may be read by the card reader 112 to assist in maintaining the attendee list. The card reader 112 may be optional.

While only once access point 108 is depicted, the given area 104 may include more than one access point 108 (and more than one card reader 112).

Furthermore, in some examples, the access point 108 may be controlled to be locked and unlocked by the device 102.

The cameras 106-2, 106-3 are located in the given area 104 at given locations. The device 102 may receive images from the cameras 106-2, 106-3, which may be used by the device 102 to determine locations associated with persons 110 in the given area 104. Such locations may include current locations and/or predicted locations of the persons 110, as described in more detail below.

However, as depicted, a camera 106-4 is located outside the given area 104, for example at a location that may be considered “safe” and/or lower risk, such as an evacuation meeting point, and the like.

In general, the cameras 106 acquire the images 107, which may include images 107 of persons 110 within their respective fields-of-view, and provide the images 107 to the device 102.

However, some persons 110 may be in a field-of-view (FOV) of a camera 106 while other persons 110 may not be in a FOV of a camera 106. For example, the persons 110-2 are understood to be within the FOV of the camera 106-2, and the person 110-3 is understood to be within the FOV of the camera 106-3. Such persons 110-2, 110-3 being within a FOV of a camera 106-2, 106-3 are understood be monitored by the cameras 106; put another way, as the persons 110-2, 110-3 are within a FOV of a camera 106, their images are understood to appear in the images 107. In contrast, the person 110-1 is alone in a room of the given area 104 that is not being monitored by a camera 106 and hence an image of the person 110-1 does not appear in the images 107. Whether or not an image of a person 110 appears in the images 107 may be used to determine whether or not a person 110 is being monitored by the cameras 106 as described in more detail below.

Furthermore, as will be described in more detail below, certain locations associated with the given area 104, which may be inside or outside (e.g., proximal to) the given area 104 may be determined to be, and/or designated as, highest risk locations, intermediate risk locations or lowest risk locations, and which may depend on an incident that is occurring at the given area 104, and/or a location of the incident, as described in more detail below.

As depicted, the device 102 has access to a memory 114, which may be provided in the form of a database, and the like, and which may be external (e.g., as depicted) and/or internal to the device 102.

As depicted, the memory 114 stores:
POI registration data 116 comprising data associated with the persons 110 that have registered with the device 102. Using the example of the given area 104 being a school, the persons 110 may comprise any suitable combination of students, teachers, employees, and visitors that have registered with the device 102, for example by providing an image (e.g., a photo) of themselves and emergency contact information, which may include, but is not limited to, communication addresses and/or telephone numbers, and the like, of parents, spouses, etc. It is understood that the images of the registered images of the persons 110 are but one example of biometric data that may be stored in the POI registration data 116, and any suitable type of biometric data, that may be determined from images, is within the scope of the present specification, including, but not limited to, gait data, indicative of a distinctive manner in which a person 110 walks. The POI registration data 116 may include any other suitable information, including, but not limited to, any other suitable biometric data of the persons 110 (e.g., gait data indicative of a distinct manner of how a person 110 walks), The POI registration data 116 may include any other suitable information, including, but not limited to, any other suitable biometric data of the persons 110 (e.g., gait data indicative of a distinct manner of how a person 110 walks), The POI registration data 116 may include any other suitable information, including, but not limited to, names of the persons 110, addresses of the persons 110, card numbers of RFID cards, and the like, issued to the persons 110, that may be read by the card reader 112. Furthermore, the POI registration data 116 may be acquired in any suitable manner.
A map 118, which comprises electronic map data of the given area 104, as well as locations of the cameras 106, including a location of the camera 106-4, which is located outside the given area 104. Hence, the map 118 may comprise an electronic map data of the given area 104, as well as any suitable areas proximal to the given area 104, such as an area that includes the location of the camera 106-4. The map 118 may further include locations of sensors in the given area 104, such as locations of fire alarms, smoke detectors, and the like. For example, as depicted, a sensor 119, such as a smoke detector, may be located in the given area 104, and the sensor 119 is in communication with the device 102. While only one sensor 119 is depicted, the system 100 may comprise a plurality of sensors 119 generally configured to sense and/or receive input indicative of an incident associated with the given area 104.
An attendee list 120 of persons located within the given area 104 that is maintained by the device 102 using images 107 received from the camera 106-1, which may include images of persons 110 entering or exiting the access point 108. The device 102 may compare the images 107 from the camera 106-1 with images of the persons 110 stored at the POI registration data 116 to identify a person 110 entering or exiting the access point 108. When a person 110 enters the given area 104 via the access point 108, and identified by comparing their image from the POI registration data 116 with the images 107, the attendee list 120 is updated to add the person 110 to the attendee list 120. When a person 110 exits the given area 104 via the access point 108, and identified by comparing their image from the POI registration data 116 with the images 107, the attendee list 120 is updated to remove the person 110 from the attendee list 120. In this manner, the attendee list 120 is understood to represent persons 110 in the given area 104 at any given time. Alternatively, or in addition, a person 110 may provide a respective card to the card reader 112 to indicate their entering or exiting the given area 104; the card number read by the card reader 112 may be used to identify and/or confirm the person 110 entering or exiting the given area 104 via the access point 108 and update the attendee list 120 accordingly.

As depicted, the system 100 further comprises at least one communication device 124 associated with communication addresses registered in the POI registration data 116. For example, the depicted communication device 124 may be operated by a user 126 who is a parent or spouse or relative or emergency contact of a person 110, and the telephone number, and the like, of the depicted communication device 124 may be stored in association with such a person 110.

As depicted, the system 100 further comprises at least one communication device 128 associated with a first responder 130, such as a police officer (e.g., as depicted), a fire fighter, an emergency medical technician, and the like. While not depicted, the memory 114 may further store, and/or the device 102 may have access to, a communication address of the at least one communication device 128.

As depicted, the system 100 further comprises a public-safety answering point (PSAP) 132, such as a 911 call center, a dispatch center for first responders, and the like. In some examples, the device 102 may have access to a communication address of the at least one communication device 128 via the PSAP 132.

While not depicted, the device 102 may be in further communication with one or more communication devices of one or more of the persons 110, and the like.

As depicted, the device 102 is generally configured to communicate with the communication devices 124, 128 and the PSAP 132. In some examples, as depicted, the communication device 124 may communicate with the PSAP 132, for example via a communication link 134, which may represent a 911 call to the PSAP 132 from the communication device 124.

The device 102 may be further configured to connect, transfer and/or forward calls between the communication device 124 and the PSAP 132 to the communication device 128. For example, an ongoing call between the communication device 124 and the PSAP 132 may be connected to the communication device 128 such that the user 126 and the first responder 130 may communicate. Such functionality to connect, transfer and/or forward calls may be implemented in any suitable manner. For example, the PSAP 132 may be configured for such functionality and the device 102 may instruct the PSAP 132 to connect, transfer and/or forward calls between the communication device 124 and the PSAP 132 to the communication device 128. Alternatively, the device 102 may be in communication with call connection apparatus (not depicted) within a communication network (not depicted) used to implement calls, and the device 102 may instruct such a call connection apparatus connect, transfer and/or forward calls between the communication device 124 and the PSAP 132 to the communication device 128.

In general, the device 102 is configured to determine that the given area 104 meets a given condition, for example such as determining that an incident and/or a public-safety incident, is occurring at, and/or in association with, the given area 104. In some examples, such a determination may occur by one or more of: receiving images from the cameras 106 (including, but not limited to, the images 107); information from sensors 119, and the like, located at the given area 104, such as smoke detectors, fire alarms, and the like; receiving information from the PSAP 132 indicative of an incident; and/or in any other suitable manner. Hereafter the term incident may be understood to include, but is not limited to, a public-safety incident such as a fire associated with the given area 104, a person with a weapon at and/or proximal the given area 104, and/or any other suitable type of incident.

In response to determining that the given area meets a given condition, the device 102 uses a current version of the attendee list 120 to generate a list of POIs within the given area 104. For example, POIs within the given area 104 may include persons 110 within the given area 104 as represented by a current version of the attendee list 120 when the given condition is met.

The device 102 categorizes, using images 107 received from the cameras 106, the POIs on the POI list into given categories based on: whether a POI is being monitored by the cameras 106; whether a location associated with the POI is determined; and, the location associated with the POI, when determined.

In general, a POI may be in a higher risk category when the POI is not being monitored by the cameras 106, for example as indicated by the POI not being present in the images 107 from the cameras 106.

A POI may be in an intermediate risk category when the POI is being monitored by the cameras 106, for example as indicated by the POI being present in images 107 from the cameras 106, and the POI located within the given area 104 at designated intermediate risk locations. For example, the device 102 may determine that a location of the POI is an intermediate risk location based on the location of the POI relative to where the incident associated with the given area 104 is occurring, such as the location of the POI relative to a fire and/or a person with a weapon in the given area 104.

A POI may be in a lower risk category when the POI is being monitored by the cameras 106, for example as indicated by the POI being present in images 107 from the cameras 106, and the POI located at designated lower risk locations. For example, the device 102 may determine that a location of the POI is a lower risk location based on the location of the POI relative to where the incident associated with the given area 104 is occurring, such as the location of the POI relative to a fire and/or a person with a weapon in the given area 104. In a particular example, the location of the camera 106-4 may comprise a lower risk location as the camera 106-4 is located outside the given area 104.

In general, the device 102 may determine a location of a POI by using the map 118 to determine a location of a camera 106 that provides an image 107 of the POI. Furthermore, the device 102 may predict a location of a POI by tracking movement of the POI via the images 107. For example, a POI may initially be in an image 107 acquired by the camera 106-2 and later be in an image 107 acquired by the camera 106-1 (e.g., the POI exits the given area 104 via the access point 108), such that the device 102 may predict that the POI is headed to the location of the camera 106-4 (e.g., prior to the POI being in images 107 from the camera 106-4). Similarly, a POI may initially be in successive images 107 acquired by the camera 106-2 that indicate movement of the POI towards the access point 108, such that the device 102 may predict that the POI is headed to the access point 108 (e.g., to exit the given area 104) and predict that a location of the POI is external to the given area 104, which may be designated as a lowest risk location.

The device 102, having categorized a POI, generally causes one or more respective electronic actions to occur in relation to the POI, the one or more respective electronic actions associated with a given category into which the POI is categorized. Such electronic actions may include, but are not limited to: highest risk electronic actions implemented in conjunction with POIs categorized into a highest risk category; intermediate risk electronic actions implemented in conjunction with POIs categorized into an intermediate risk category; and lowest risk electronic actions implemented in conjunction with POIs categorized into a lowest risk category. Such electronic actions are described in more detail below. Furthermore, such risk categories, and associated electronic actions, are understood to be examples, and other types and/or numbers of risk categories, and associated electronic actions, are within the scope of the present specification.

Attention is next directed to FIG. 2, which depicts a schematic block diagram of an example of the device 102. While the device 102 is depicted in FIG. 2 as a single component, functionality of the device 102 may be distributed among a plurality of components, such as a plurality of servers and/or cloud computing devices.

As depicted, the device 102 comprises: a communication interface 202, a processing component 204, a Random-Access Memory (RAM) 206, one or more wireless transceivers 208, one or more wired and/or wireless input/output (I/O) interfaces 210, a combined modulator/demodulator 212, a code Read Only Memory (ROM) 214, a common data and address bus 216, a controller 218, and a static memory 220 storing at least one application 222. The controller 218 is understood to be communicatively connected to other components of the device 102 via the common data and address bus 216. Hereafter, the at least one application 222 will be interchangeably referred to as the application 222.

Furthermore, while the memories 206, 214 are depicted as having a particular structure and/or configuration, (e.g., separate RAM 206 and ROM 214), memory of the device 102 may have any suitable structure and/or configuration.

While not depicted, the device 102 may include one or more of an input component and/or a display screen, which, when present, may be communicatively coupled to the controller 218.

As shown in FIG. 2, the device 102 includes the communication interface 202 communicatively coupled to the common data and address bus 216 of the processing component 204.

The processing component 204 may include the code Read Only Memory (ROM) 214 coupled to the common data and address bus 216 for storing data for initializing system components. The processing component 204 may further include the controller 218 coupled, by the common data and address bus 216, to the Random-Access Memory 206 and the static memory 220.

The communication interface 202 may include one or more wired and/or wireless input/output (I/O) interfaces 210 that are configurable to communicate with other components of the system 100. For example, the communication interface 202 may include one or more wired and/or wireless transceivers 208 for communicating with other suitable components of the system 100.

In particular, the communication interface 202 is configured to communicate with the cameras 106 monitoring a given area 104, and optionally the communication devices 124, 128 and the PSAP 132.

Hence, the one or more transceivers 208 may be adapted for communication with one or more communication links and/or communication networks used to communicate with the other components of the system 100. For example, the one or more transceivers 208 may be adapted for communication with one or more of the Internet, a digital mobile radio (DMR) network, a Project 25 (P25) network, a terrestrial trunked radio (TETRA) network, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3rd Generation Partnership Project) networks, a 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network. Hence, the one or more transceivers 208 may include, but are not limited to, a cell phone transceiver, a DMR transceiver, P25 transceiver, a TETRA transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

The communication interface 202 may further include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to a combined modulator/demodulator 212.

The controller 218 may include ports (e.g., hardware ports) for coupling to other suitable hardware components of the system 100.

The controller 218 may include one or more logic circuits, one or more processors, one or more microprocessors, one or more GPUs (Graphics Processing Units), and/or the controller 218 may include one or more ASIC (application-specific integrated circuits) and one or more FPGA (field-programmable gate arrays), and/or another electronic device. In some examples, the controller 218 and/or the device 102 is not a generic controller and/or a generic device, but a device specifically configured to implement functionality for causing electronic actions for categories of persons-of-interest. For example, in some examples, the device 102 and/or the controller 218 specifically comprises a computer executable engine configured to implement functionality for causing electronic actions for categories of persons-of-interest.

The static memory 220 comprises a non-transitory machine readable medium that stores machine readable instructions to implement one or more programs or applications. Example machine readable media include a non-volatile storage component (e.g., Erasable Electronic Programmable Read Only Memory (“EEPROM”), Flash Memory) and/or a volatile storage component (e.g., random-access memory (“RAM”)). In the example of FIG. 2, programming instructions (e.g., machine readable instructions) that implement the functionality of the device 102 as described herein are maintained, persistently, at the memory 220 and used by the controller 218, which makes appropriate utilization of volatile storage during the execution of such programming instructions.

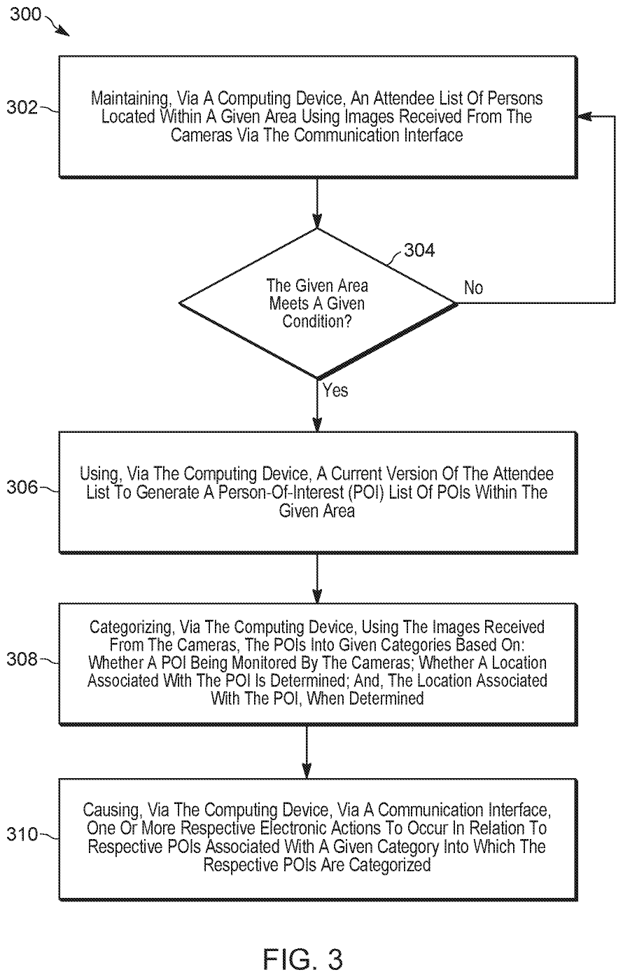

Furthermore, the memory 220 stores instructions corresponding to the at least one application 222 that, when executed by the controller 218, enables the controller 218 to implement functionality for causing electronic actions for categories of persons-of-interest, including but not limited to, the blocks of the method set forth in FIG. 3.

Furthermore, while not depicted, the memory 114 may be combined, and/or partially combined, with the memory 220, such that the memory 220 may store one or more of the POI registration data 116, the map 118, and/or the attendee list 120.

Furthermore, as depicted, the memory 220 stores condition data 224, which may comprise data that indicates one or more conditions that, when met by the given area 104, causes the device 102 to generate a POI list, categorize the POIs and implement electronic actions. For example, the condition data 224 may indicate that when a fire alarm (e.g., as represented by the sensor 119) is pulled at the given area 104, the given area 104 meets a given condition. Similarly, the condition data 224 may indicate that when an image 107 of a fire or person with a weapon is present in the images 107, the given area 104 meets a given condition. Similarly, the condition data 224 may indicate that when an indication of an incident and/or a public-safety incident occurring in association with the given area 104 is received from the PSAP 132, the given area 104 meets a given condition. In particular, the condition data 224 may comprise data indicating various types of incidents and/or public-safety incidents, which, when they occur in association with the given area 104, the given area 104 is understood to meet a given condition. Alternatively, the condition data 224 may be stored at the memory 114. While the condition data 224 is depicted as being stored separately from the application 222, the condition data 224 may be stored as one or more components and/or modules of the application 222.

Furthermore, as depicted, the memory 220 stores electronic action data 226, which may comprise instructions for implementing highest risk electronic actions, intermediate risk electronic actions, and lowest risk electronic actions. Alternatively, the electronic action data 226 may be stored at the memory 114. While the electronic action data 226 is depicted as being stored separately from the application 222, the electronic action data 226 may be stored as one or more components and/or modules of the application 222.

In illustrated examples, when the controller 218 executes the one or more applications 222, the controller 218 is enabled to: maintain an attendee list of persons located within a given area using images received from the cameras via the communication interface 202; in response to determining that the given area meets a given condition: use a current version of the attendee list to generate a POI list of POIs within the given area; categorize, using the images received from the cameras, the POIs into given categories based on: whether a POI is being monitored by the cameras; whether a location associated with the POI is determined; and, the location associated with the POI, when determined; and cause, via the communication interface 202, one or more respective electronic actions to occur in relation to respective POIs associated with a given category into which the respective POIs are categorized.

The application 222 and/or the condition data 224 and/or the electronic action data 226 may include numerical algorithms to implement the functionality of the device 102.

Alternatively, the application 222 and/or the condition data 224 and/or the electronic action data 226 include machine learning and/or deep-learning based algorithms and/or neural networks (and/or classifiers and/or neural network layers, and the like), and the like, which have been trained to implement the functionality of the device 102. Furthermore, in these examples, machine learning and/or deep-learning based algorithms and/or neural networks of the application 222 and/or the condition data 224 and/or the electronic action data 226 may initially be operated by the controller 218 in a training mode to train the machine learning and/or deep-learning based algorithms and/or neural networks of the application 222 and/or the condition data 224 and/or the electronic action data 226 to implement the functionality of the device 102. Furthermore, machine learning feedback loops may be used to further train the machine learning and/or deep-learning based algorithms and/or neural networks of the application 222 and/or the condition data 224 and/or the electronic action data 226 to better implement the functionality of the device 102.

The one or more machine-learning algorithms and/or deep learning algorithms and/or neural networks of the application 222 and/or the condition data 224 and/or the electronic action data 226 may include, but are not limited to: a generalized linear regression algorithm; a random forest algorithm; a support vector machine algorithm; a gradient boosting regression algorithm; a decision tree algorithm; a generalized additive model; neural network algorithms; deep learning algorithms; evolutionary programming algorithms; Bayesian inference algorithms, reinforcement learning algorithms, and the like. However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like, in some environments, such schools, prisons, and the like. Any suitable machine-learning algorithm and/or deep learning algorithm and/or neural network is within the scope of present examples.

While details of the communication devices 124, 128 and the PSAP 132 are not depicted, the communication devices 124, 128 and the PSAP 132 may have components similar to the device 102 but adapted, for the respective functionality thereof. For example, the communication devices 124, 128 may include respective display screens for rendering messages received from the device 102, and the PSAP 132 may comprise one or more PSAP terminals that includes a respective display screen and a respective headset for a PSAP operator and/or a dispatcher, and the like.

Attention is now directed to FIG. 3, which depicts a flowchart representative of a method 300 for causing electronic actions for categories of persons-of-interest. The operations of the method 300 of FIG. 3 correspond to machine readable instructions that are executed by the device 102, and specifically the controller 218 of the device 102. In the illustrated example, the instructions represented by the blocks of FIG. 3 are stored at the memory 220 for example, as the application 222. The method 300 of FIG. 3 is one way that the controller 218 and/or the device 102 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps.” The method 300 of FIG. 3 may be implemented on variations of the system 100 of FIG. 1, as well.

At a block 302, the controller 218, and/or the device 102, maintains the attendee list 120 of persons 110 located within the given area 104 using images received from the cameras 106 via the communication interface 202, including, but not limited to, the images 107.

For example, as images 107 are received at the device 102 from the camera 106-1 monitoring the access point 108, the images 107 may be compared to images of persons 110 stored in the POI registration data 116 to add or remove persons 110 at the attendee list 120. The attendee list 120 may alternatively be maintained based on data from the card reader 112.

In example, where an image 107 of a person 110 attempting to enter the access point 108 is not found in the POI registration data 116, the controller 218, and/or the device 102 may lock the access point 108 to prevent entry, and provide a message to a communication device of a person 110 already registered in the POI registration data 116, such a school administrator, and the like, to cause that the already registered person 110 to meet the person 110 attempting to enter the access point 108, to assist the person 110 attempting to enter the access point 108 with registering. For example, an image of the person 110 attempting to enter the access point 108 may be acquired using any suitable camera (including, but not limited to a camera of the communication device of the person 110 already registered in the POI registration data 116) and uploaded to the device 102, along with their name, emergency contact information (e.g., a communication address) of a spouse, a parent, and the like; the device 102 may update the POI registration data 116 accordingly. The access point 108 may be unlocked at any suitable time such that the person 110 that attempted to enter the access point 108, that was initially not found in the POI registration data 116, may enter the access point 108, such that their image 107 is acquired by the camera 106-4 and the attendee list 120 is updated accordingly.

At a block 304, the controller 218, and/or the device 102, determines whether the given area 104 meets a given condition. For example, the given condition may be one of the conditions indicated by the condition data 224, as described herein.

In particular, the controller 218, and/or the device 102, may determine whether the given area 104 meets a given condition based on the images 107, which may show a fire, a person with a weapon, and/or any other images 107 indicative of an incident (e.g., a public-safety incident) occurring in association with the given area 104.

Alternatively, the controller 218, and/or the device 102, may determine whether the given area 104 meets a given condition based on information received from the PSAP 132, such as a message indicative of an incident occurring in association with the given area 104.

Alternatively, the controller 218, and/or the device 102, may determine whether the given area 104 meets a given condition based on data received from the sensor(s) 119 associated with the given area 104, such as receiving an indication of an incident from a fire alarm, a smoke detector, and the like.

In response to determining that the given area 104 does not meets a given condition (e.g., a “NO” decision at the block 304), the controller 218, and/or the device 102, continues to maintain the attendee list 120 at the block 302.

However, in response to determining that the given area 104 meets a given condition (e.g., a “YES” decision at the block 304), at a block 306, the controller 218, and/or the device 102, uses a current version of the attendee list 120 to generate a POI list of POIs within the given area 104.

In particular, in response to determining that the given area 104 meets a given condition, the controller 218, and/or the device 102 may generate a copy of the attendee list 120. The POI list may comprise the copy of the attendee list 120 in the state the attendee list 120 is in when the given area 104 meets the given condition.

As such, the POI list is understood to represent a list of the persons 110 in the given area 104 when the given area 104 meets the given condition including, but not limited to, their registered images, and their registered emergency contact information. Put another way, in specific examples, the POI list represents a list of persons 110, and their registered images, in the given area 104 when the controller 218 and/or the device 102 determines that an incident (e.g., a public-safety incident) is occurring in association with the given area 104.

Hereafter, the persons 110 on the POI list will be interchangeably referred to as POIs 110 (and/or a POI 110). In particular, all of the depicted persons 110 in FIG. 1 are understood to be POIs 110 on the POI list, presuming all the depicted persons 110 are in the given area 104 when the given condition is met.

At a block 308, the controller 218, and/or the device 102, categorizes, using the images 107 received from the cameras 106, the POIs 110 into given categories based on: whether a POI 110 is being monitored by the cameras 106; whether a location associated with the POI 110 is determined; and, the location associated with the POI 110, when determined.

For example, the controller 218, and/or the device 102 receives the images 107 and compares the images 107 with images in the POI list to identify the POIs 110 in the images 107. Such a comparison may be performed according to any suitable process.

For example, the images 107 may be processed by the device 102 to extract biometric data, including, but not limited to, feature vectors (and the like) of faces of the persons 110 in the images 107; similarly, images of the POI list may be processed by the device 102 to extract biometric data, including, but not limited to, feature vectors (and the like) of faces of the POIs 110 in the images of the POI list. The respective biometric data of persons 110 in the images 107 and POIs 110 in the POI list may be compared to identify POIs 110 in the images 107 (e.g., using facial recognition techniques). However, any suitable recognition process and/or facial recognition process may be implemented to identify the POIs 110 in the images 107, using any suitable type of biometric data including, but not limited to facial landmarks, gait data and the like.

Furthermore, in some examples, as the attendee list 120 is generated and/or updated, facial vectors, and/or other suitable biometric data, may be extracted from images of the persons 110 stored at the attendee list 120, such that the POI list also includes such biometric data. By including such biometric data at the attendee list 120, processing of the POI list during an incident may be reduced relative to when such biometric data is not included at the attendee list 120.

Alternatively, when the POI list is generated, such biometric data may be generated from the images of the persons 110 at the attendee list 120.

Hence, the controller 218, and/or the device 102 are understood to be generally configured to determine whether or not a POI 110 on the POI list is being monitored by the cameras 106 based on whether or not a POI 110 on the POI list is present in the images 107 or not present in the images 107. Put another way, when a POI 110 on the POI list is present in the images 107, the controller 218, and/or the device 102 determines that the POI 110 is being monitored by the cameras 106; conversely, when a POI 110 on the POI list is not present in the images 107, the controller 218, and/or the device 102 determines that the POI 110 is not being monitored by the cameras 106.

When a POI 110 is monitored by the camera 106, the controller 218, and/or the device 102 may determine an associated location of the POI 110 based on the respective location of the camera 106 and/or cameras 106 that acquired images 107 of the POI 110, for example as stored in the map 118. Put another way, the images 107 received at the device 102 may include metadata identifying a respective camera 106 that generated an image 107, which may be used by the controller 218, and/or the device 102 to locate the camera 106 on the map 118, to determine the location of the camera 106 and hence the location of the POI 110. However, as has been previously described, an associated location of a POI 110 may include a present location of the POI 110, or a predicted location of the POI 110 as determined from the images 107.

Hence, for example, presuming the controller 218 and/or the device 102 has access to the memory 114 storing registered images of the persons 110 and respective associated locations of the cameras 106 (e.g., in the POI registration data 116 and the map 118), the method 300 may further include the controller 218 and/or the device 102: determining whether a POI 110 is being monitored by the cameras 106 by comparing the images 107 from the cameras 106 with the registered images; and determining the location of the POI 110 using a respective location, as stored at the memory 214, of a camera 106 that provided an image 107 in which the POI 110 was detected using the registered images.

Furthermore, some locations in the given area 104, or associated with the given area 104, may be categorized as highest risk, intermediate risk, or lowest risk locations.

For example, the controller 218, and/or the device 102 may determine a location of an incident that caused the given area 104 to meet a given condition at the block 304. For example, using any suitable video analysis techniques, the location of the incident may be determined from the images 107 (e.g., to identify a location of a fire and/or a person with a weapon). Alternatively, the location of the incident may be determined from a location of a sensor 119, from which information indicating the incident was received (e.g., which may be received with metadata identifying the sensor 119 such that the sensor 119 may be located on the map 118). Alternatively, the location of the incident may be indicated by information received from the PSAP 132.

Furthermore, when the incident includes a fire, a person with a weapon, and the like, the location of the incident may expand and/or move, and the controller 218, and/or the device 102 may track expansion and/or movement of the incident using the images 107.

When the location of the incident is determined, any suitable criteria may be used to categorize locations associated with the given area 104, and which may depend on a type of the incident.

For example, when the incident comprises a fire; locations that are within a given distance of the fire, such as 10 meters, 20 meters, amongst other possibilities, may be designated as highest risk locations; locations that are within a respective given distance from the high risk locations, such as 10 meters, 20 meters, amongst other possibilities, may be designated as intermediate risk locations; locations that are outside the intermediate risk locations, may be designated as lowest risk locations.

Similarly, when the incident comprises a person with a weapon; locations that are within a line-of-sight of the person or the weapon may be designated as highest risk locations; locations outside the line-of-sight of the person or the weapon may be designated as highest risk locations but within a given distance of person, such as 10 meters, 20 meters, amongst other possibilities, may be designated as intermediate risk locations; locations that are outside the intermediate risk locations, may be designated as lowest risk locations.

In some examples, certain given locations, such as locations outside the given area 104, may be designated as lowest risk locations.

Regardless, categories of locations may be determined by the controller 218 and/or the device 102 using any given criteria.

In particular, at the block 308, the controller 218, and/or the device 102 may categorize a POI 110 into a highest risk category, an intermediate risk category and a lowest risk category, depending on whether or not the POI 110 is being monitored by the cameras 106 and/or their location and/or a risk category of their location.

At a block 310, the controller 218, and/or the device 102, causes and/or initiates, via the communication interface 202, one or more respective electronic actions to occur in relation to respective POIs associated with a given category into which the respective POIs are categorized.

For example, when a POI 110 is in a highest risk category, highest risk electronic actions may be implemented and/or may be caused to be implemented. Similarly, when a POI 110 is in an intermediate risk category, intermediate risk electronic actions may be implemented and/or may be caused to be implemented. Similarly, when a POI 110 is in a lowest risk category, lowest risk electronic actions may be implemented and/or may be caused to be implemented. The electronic actions to be implemented may be indicated by the electronic action data 226.

In some examples, the device 102 may implement an electronic action. However, in other examples, the device 102 may instruct another component of the system 100 to perform the electronic action. Hence, the controller 218, and/or the device 102, may cause and/or initiate one or more respective electronic actions to occur via implementation of an electronic action by the device 102 and/or by instructing another component of the system 100 to perform the electronic action.

For example, at the block 308 the controller 218, and/or the device 102 may categorize a portion of the POIs 110 into a designated highest risk category by determining that the portion of the POIs 110 are not being monitored by the cameras 106; in these examples, at the block 310 the controller 218, and/or the device 102 may cause the one or more respective electronic actions associated with the designated highest risk category to occur in relation to the portion of the POIs 110.

For example, with brief reference to FIG. 1, as the person 110-1 is not being monitored by the cameras 106, and as the person 110-1 is understood to be a POI 110 on the POI list, the person 110-1 (e.g., the POI 110-1) may be categorized into a designated highest risk category and one or more respective electronic actions associated with the designated highest risk category may occur in relation to the person and/or the POI 110-1.

In particular, the POI 110-1 is understood to be categorized into the designated highest risk category as a location of the POI 110-1 may not be determined from the images 107.

Alternatively, a POI 110 may be categorized into the designated highest risk category when the POI 110 is monitored by the cameras 106, and the location of the POI 110 is determined, and the location of the POI 110 comprises a highest risk location. Put another way, at the block 308, the controller 218, and/or the device 102 may categorize a portion of the POIs 110 into a designated highest risk category by determining that: the portion of the POIs 110 are being monitored by the cameras 106; and respective associated locations of the portion of the POIs 110 within the given area 104 comprise designated highest risk locations.

In some examples, the one or more respective electronic actions associated with the designated highest risk category may comprise initiating one or more calls to one or more communication devices associated with communication addresses registered in association with the portion of the POIs 110.

In a particular example, a communication address of the communication device 124 may be registered at the POI registration data 116 in association with the POI 110-1 as an emergency contact (e.g., the user 126 may be a parent of the POI 110-1). When the POI 110-1 is determined to be in the designated highest risk category due to the POI 110-1 not being monitored by the cameras 106, a call may be initiated between the communication device 128 of the first responder 130 and the communication device 124, such that the first responder 130 may talk to the user 126 to ask about behavior patterns of the POI 110-1, such where the POI 110-1 might hide during an incident. For example, the user 126 may tell the first responder 130 that the POI 110-1 might hide in a washroom stall or a closet, such that the first responder 130 may then enter the given area 104 to search for the person 110-1 in such locations.

In other examples, the one or more respective electronic actions associated with the designated highest risk category comprises connecting one or more public-safety answering point (PSAP) calls from one or more registered communication addresses, associated with the portion of the POIs 110, to one or more communication devices associated with one or more first responders.

For example, communication device 124 may be engaged in a call to the PSAP 132 as represented by the communication link 134; as such, the call represented by the communication link 134 may be referred as a PSAP call (e.g., a call to the PSAP 132). The controller 218 and/or the device 102 may instruct the PSAP 132 to connect the call represented by the communication link 134 to the communication device 128 of the first responder 130. In some of these examples, the device 102 may request, from the PSAP 132, information on calls currently being conducted at the PSAP 132 with communication devices having communication addresses indicated in the POI registration data 116 for POIs 110 on the POI list, so that the device 102 may specifically instruct the PSAP 132 to connect an ongoing call from communication device 124 to the communication device 128. In other examples, the device 102 may provide the PSAP 132 with communication addresses indicated in the POI registration data 116 for POIs 110 on the POI list that are in the highest risk category and instruct the PSAP 132 to connect any calls received from such communication addresses to the communication device 128 of the first responder 130 (or another communication device of another first responder).

In other examples, the one or more respective electronic actions associated with the designated highest risk category comprise providing information collected during one or more public-safety answering point (PSAP) calls, from one or more registered communication addresses, associated with the portion of the POIs 110, to one or more communication devices associated with one or more first responders.

For example, during the call represented by the communication link 134, an operator at the PSAP 132 may collect information from the user 126 and store such information, for example in a call record and/or an incident record. During or after call represented by the communication link 134, the device 102 may instruct the PSAP 132 to provide any information collected on the call to the communication device 128 of the first responder 130 (or another communication device of another first responder).

The device 102 may cause any suitable combination of one or more highest risk electronic actions to be implemented, which may comprise an electronic search and rescue protocol.

Furthermore, the device 102 may distinguish between a POI 110 being in a highest risk category due to a POI 110 not being monitored by the cameras 106, or due to a POI 110 being in a highest risk location (e.g., and monitored by the cameras 106). For example, when a POI 110 is not monitored by the cameras 106, any of the aforementioned highest risk electronic actions may be caused. However, when a POI 110 is determined to be in a highest risk location, any of the aforementioned highest risk electronic actions may be caused and/or an electronic rescue protocol may be caused and/or initiated by the device 102, which may include, but is not limited to, electronically dispatching first responders to a location of the POI 110 to attempt to rescue the POI 110.

In another example, at the block 308, the controller 218, and/or the device 102 may categorize a portion of the POIs 110 into a designated intermediate risk category by determining that: the portion of the POIs 110 are being monitored by the cameras 106; and respective associated locations of the portion of the POIs 110 within the given area 104 comprise designated intermediate risk locations. In these examples, at the block 310 the controller 218, and/or the device 102 may cause the one or more respective electronic actions associated with the designated intermediate risk category to occur in relation to the portion of the POIs 110.

For example, with brief reference to FIG. 1, the person 110-3 is being monitored by the camera 106-3, and as the person 110-1 is understood to be a POI 110 on the POI list, the person 110-3 (e.g., the POI 110-1) may be categorized into a designated intermediate risk category as their location may be determined to be an intermediate risk location (e.g., they are alone in a room and may not be in a line-of-site of a person with weapon and/or may be within a given “intermediate risk” distance from a fire; hence, one or more respective electronic actions associated with the designated intermediate risk category may occur in relation to the person and/or the POI 110-3.

In some examples, the one or more respective electronic actions associated with the designated intermediate risk category may comprise transmitting one or more messages to one or more communication devices 124 associated with communication addresses registered in association with the portion of the POIs (e.g., in the POI registration data 116).

In some examples, presuming in these examples that a communication address of the communication device 124 may be registered at the POI registration data 116 in association with the POI 110-3 as an emergency contact (e.g., the user 126 may be a parent of the POI 110-3), the controller 218 and/or device 102 may transmit, to the communication device 124, a message such as “Your relative or colleague is in an incident but we know their location” and/or any other suitable message.

In some examples, the one or more respective electronic actions associated with the designated intermediate risk category may comprise providing POI registration data 116 to one or more communication devices associated with one or more first responders, and which may include providing a location of a POI 110 in the designated intermediate risk category to the one or more communication devices associated with one or more first responders.

For example, an image and/or emergency contact information associated with the POI 110-3 may be provided to the communication device 128 of the first responder 130 (or another communication device of another first responder). The first responder 130 may use the emergency contact information to contact the user 126 by calling the communication device 124. Alternatively and/or in addition, the location of the POI 110-3 may be provided to the communication device 128 of the first responder 130, for example as indicated on the map 118.

The device 102 may cause any suitable combination of one or more intermediate risk electronic actions to be implemented, which may comprise an evacuation protocol, for example to evacuate the POI 110-3 from the given area 104 108. For example the location of the POI 110-3, as electronically provided to the communication device 128 of the first responder 130 (or another communication device of another first responder), may be part of an evacuation protocol.

In another example, at the block 308 the controller 218, and/or the device 102 may categorize a portion of the POIs 110 into a designated lowest risk category by determining that: the portion of the POIs 110 are being monitored by the cameras 106; and respective locations of the portion of the POIs 110 comprise designated lowest risk locations. In these examples, at the block 310 the controller 218, and/or the device 102 may cause the one or more respective electronic actions associated with the designated lowest risk category to occur in relation to the portion of the POIs 110.

For example, with brief reference to FIG. 1, the persons 110-2 are being monitored by the camera 106-1, and as the persons 110-2 are understood to be POIs 110 on the POI list, the persons 110-2 (e.g., the POIs 110-2) may be categorized into a designated lowest risk category as their location may be determined to be a lowest risk location (e.g., they are adjacent the access point 108 and may quickly evacuate the given area 104, and/or they may not be in a given “lowest risk” distance from a fire and/or a person with a weapon). Hence, one or more respective electronic actions associated with the designated lowest risk category may occur in relation to the persons and/or the POI s110-2.

In some examples, the one or more respective electronic actions associated with the designated lowest risk category may comprise transmitting one or more messages to one or more communication devices 124 associated with communication addresses registered in association with the portion of the POIs (e.g., in the POI registration data 116).

For example, presuming in these examples that a communication address of the communication device 124 may be registered at the POI registration data 116 in association with one of the POIs 110-2 as an emergency contact (e.g., the user 126 may be a parent of one of the POI 110-2), the controller 218 and/or device 102 may transmit, to the communication device 124, a message such as “Your relative or colleague is in an incident and is evacuating the location” and/or any other suitable message.

Alternatively, as the POIs 110-2 evacuate the given area 104 and reach the location of the camera 106-4, which may be designated as a lowest risk location, the controller 218 and/or device 102 may transmit, to the communication device 124, a message such as “Your relative or colleague is in an incident and has evacuate the location” and/or any other suitable message. In particular example of a fire at a school, the controller 218 and/or device 102 may transmit, to the communication device 124, a message such as “Fire At School; Your Child is Evacuated”, and the like.

Such an example illustrates that, as the POIs 110 change locations in the given area 104 different messages may be transmitted.

Furthermore, the controller 218 and/or the device 102 may continue to determine risk categories of the POIs 110 as their locations change and/or as their monitoring status by the cameras 106 changes.

For example, if the POI 110-1 and/or the POI 110-3 leave their respective locations, such that camera 106-2 acquires their images, their risk category may change to the designated lowest risk category, and an associated lowest risk electronic action may be implemented. Similarly, if one or more of the POI 110-1, 110-2 are no longer monitored by the cameras 106, their risk category may change to the designated highest risk category, and an associated highest risk electronic action may be implemented.

Hence, the method 300 may further comprise, the controller 218 and/or the device 102: recategorizing, using the images 107 received from the cameras 106, a given POI from a first category of the given categories to a second category of the given categories based on one or more of: the given POI changing locations, as determined from the images 107; and/or a monitoring status the given POI changing, as determined from the images 107.

As has been previously described, a subset of the cameras 106 may be located at access points 108 to the given area 104, such as the camera 106-1. In these examples, the method 300 may further comprise, the controller 218 and/or the device 102: maintaining the attendee list 120 using respective images 107 received from the subset of the cameras 106 indicating respective persons 110 entering or exiting the given area 104 via the access points 108. When a person 110 enters the given area 104, the POI list may be updated, for example such that new persons 110 entering the given area 104 are designated as POIs 110 and categorized. In some examples, when a person 110 (e.g., a POI 110) exits the given area 104, the POI list may not be updated, for example to continue to implement monitor such POIs 110 via cameras 106 located outside of the given area 104 106, such as the camera 106-4. However, on other examples, when a POI 110 exits the given area 104 the POI list may be updated to remove them as a POI 110 on the POI list.

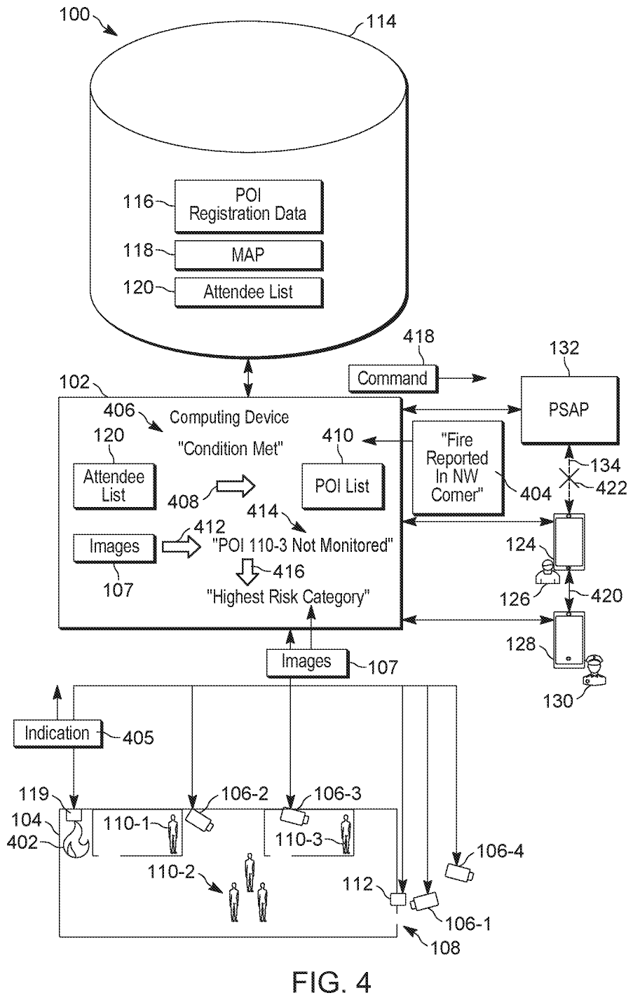

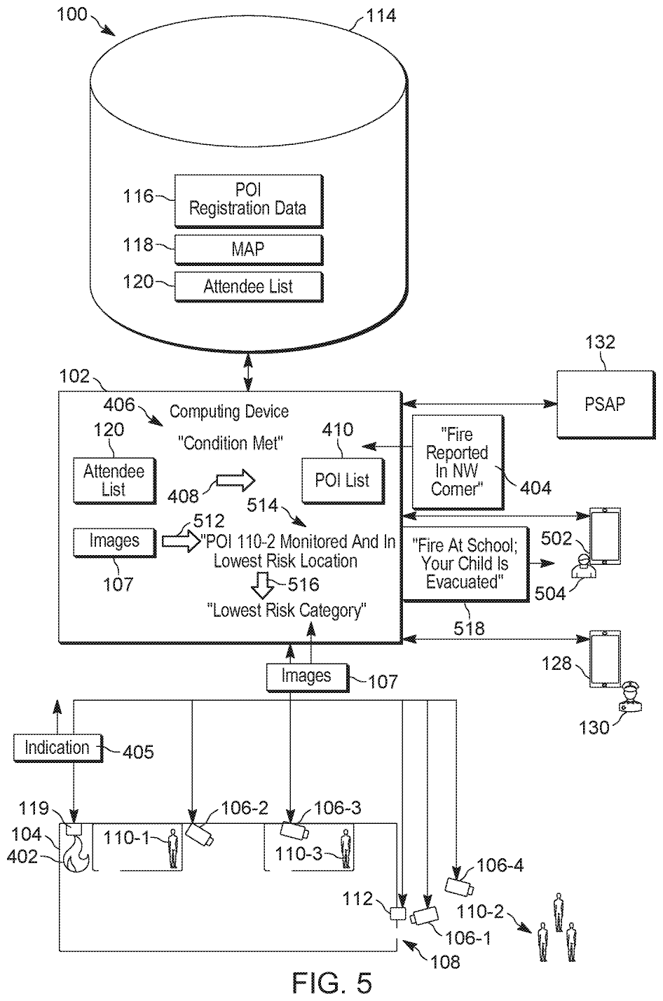

Attention is next directed to FIG. 4 and FIG. 5, which depicts examples of the method 300. FIG. 4 and FIG. 5 are substantially similar to FIG. 1, with like components having like numbers.

In the example of FIG. 4, a communication address of the communication device 124 may be registered at the POI registration data 116 in association with the POI 110-1 as an emergency contact (e.g., the user 126 may be a parent of the POI 110-1).

In the description of FIG. 4, it is understood that the device 102 is maintaining (e.g., at the block 302 of the method 300), the attendee list 120.

As depicted, a fire 402 is occurring in a corner of the given area 104, and the PSAP 132 provides an indication 404 of the fire 402 to the device 102, which includes a location of the fire 402 (e.g., “Fire Reported In NW Corner”). The indication 404 may be provided when the fire 402 is reported to the PSAP 132, for example via a call (using a communication device) from a passerby to the given area 104 who notices the fire 402 and/or via a call (using a communication device) from someone inside the given area 104 who notices the fire 402 (e.g., such as one of the persons 110).

Similarly, the sensor 119, which is depicted as being located adjacent the fire 402, provides an indication 405 of the fire to the device 102 (e.g., the sensor 119 in this example may comprise a smoke detector and the indication 405 may comprise an indication of detection of smoke). The indication 405 may further comprise metadata indicative of a location of the sensor 119 and/or an identifier of the sensor 119 which enables the device 102 to locate the sensor 119, and hence the fire 402, on the map 118.

The device 102 processes the indications 404, 405 and determines (e.g., at the block 304 of the method 300) that a given condition is met (e.g., there is fire in the given area 104), for example as represented by the text 406 “Condition Met” in FIG. 4.

In response to the given condition being met, the device 102 generates (e.g., at the block 306 of the method 300, as represented by an arrow 408) a POI list 410 from the attendee list 120.

From the images 107 (e.g., as represented by the arrow 412), the device 102 determines that the POI 110-1 is not being monitored by cameras 106, for example as represented by the text 414 “POI 110-3 Not Monitored” in FIG. 4. The device 102 categorizes (e.g., at the block 308 of the method 300, as represented by the arrow 416) the POI 110-3 into a “Highest Risk Category” and causes (e.g., at the block 310 of the method 300) highest risk electronic actions to occur.

For example, as depicted, the device 102 provides a command 418 to the PSAP 132 to cause the call between the communication device 124 and the PSAP 132, as represented by the communication link 134, to be connected to the communication device 128 of the first responder 130 as represented by a communication link 420 therebetween. As depicted, the call between the communication device 124 and the PSAP 132, as represented by the communication link 134, may end, as represented by an “X” 422.

Hence, the first responder 130 and the user 126 may communicate, and the user 126 may tell the first responder 130 that the POI 110-1 might hide in a washroom stall or a closet, such that the first responder 130 may then enter the given area 104 to search for the person 110-1 in such locations.

Attention is next directed to FIG. 5, which is substantially similar to FIG. 4 with like components having like numbers, however the communication device 124 and the user 126 are replaced by the communication device 502 and the user 504 (though the communication device 124 and the user 126 may continue to be present in the system 100). In the example of FIG. 5, a communication address of the communication device 502 may be registered at the POI registration data 116 in association with one of the POIs 110-2 as an emergency contact (e.g., the user 504 may be a parent of one of the POIs 110-2).

In further contrast to FIG. 4, the POIs 110-2 have evacuated the given area 104 and are located in a FOV of the camera 106-4.

In FIG. 5, it is understood that the device 102 is maintaining (e.g., at the block 302 of the method 300), the attendee list 120.

As depicted, the fire 402 is occurring in a corner of the given area 104, the indications 404, 404 of the fire 402 are provided to the device 102, as described with reference to FIG. 4. The device 102 processes the indications 404, 405 and determines (e.g., at the block 304 of the method 300) that a given condition is met (e.g., there is fire in the given area 104), for example as represented by the text 406 “Condition Met” in FIG. 5.

In response to the given condition being met, the device 102 generates (e.g., at the block 306 of the method 300, as represented by an arrow 408) a POI list 410 from the attendee list 120.

From the images 107 (e.g., as represented by the arrow 512), the device 102 determines that one of the POIs 110-2 is being monitored by cameras 106 and is located in a lowest risk location, for example as represented by the text 514 “POI 110-2 Monitored And In Lowest Risk Location” in FIG. 5. While this example is described with respect to one of the POIs 110-2, similar determinations may occur for all the POIs 110-2.

The device 102 categorizes (e.g., at the block 308 of the method 300, as represented by the arrow 516) the POI 110-2 into a “Lowest Risk Category” and causes (e.g., at the block 310 of the method 300) lowest risk electronic actions to occur in relation to the one of the POIs 110-2.

For example, as depicted, the device 102 provides a message 518 to the communication device 502 comprising text “Fire At School; Your Child Is Evacuated” to inform the user 504 that the POI 110-2 has been evacuated from the school.

It is understood that the examples of FIG. 4 and FIG. 5 may occur in tandem.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, cannot control a display screen, cannot implement a machine learning algorithm, nor implement a machine learning algorithm feedback loop, and the like).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

Furthermore, a device provided herein may include a housing that contains at least some of the components of the device; however in some alternative examples a device may include components not all contained in a single housing, but rather within two or more different housings.

The terms “coupled”, “coupling” or “connected” as used herein can have several different meanings depending on the context, in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A device comprising:
a communication interface configured to communicate with cameras monitoring a given area; and;
a controller configured to:
maintain an attendee list of persons located within the given area using images received from the cameras via the communication interface;
in response to determining that the given area meets a given condition:
use a current version of the attendee list to generate a person-of-interest (POI) list of POIs within the given area;
categorize, using the images received from the cameras, the POIs into given categories based on: whether a POI is being monitored by the cameras; whether a location associated with the POI is determined; and, the location associated with the POI, when determined; and
cause, via the communication interface, one or more respective electronic actions to occur in relation to respective POIs associated with a given category into which the respective POIs are categorized.

2. The device of claim 1, wherein the controller is further configured to:
categorize a portion of the POIs into a designated highest risk category by determining that the portion of the POIs are not being monitored by the cameras; and
cause the one or more respective electronic actions associated with the designated highest risk category to occur in relation to the portion of the POIs.

3. The device of claim 2, wherein the one or more respective electronic actions associated with the designated highest risk category comprise initiating one or more calls to one or more communication devices associated with communication addresses registered in association with the portion of the POIs.

4. The device of claim 2, wherein the one or more respective electronic actions associated with the designated highest risk category comprise connecting one or more public-safety answering point (PSAP) calls from one or more registered communication addresses, associated with the portion of the POIs, to one or more communication devices associated with one or more first responders.

5. The device of claim 2, wherein the one or more respective electronic actions associated with the designated highest risk category comprise providing information collected during one or more public-safety answering point (PSAP) calls, from one or more registered communication addresses, associated with the portion of the POIs, to one or more communication devices associated with one or more first responders.

6. The device of claim 1, wherein the controller is further configured to:
categorize a portion of the POIs into a designated intermediate risk category by determining that: the portion of the POIs are being monitored by the cameras; and
respective locations of the portion of the POIs within the given area comprise designated intermediate risk locations; and
cause the one or more respective electronic actions associated with the designated intermediate risk category to occur in relation to the portion of the POIs.

7. The device of claim 1, wherein the controller is further configured to:
categorize a portion of the POIs into a designated lowest risk category by determining that: the portion of the POIs are being monitored by the cameras; and respective locations of the portion of the POIs comprise designated lowest risk locations; and
cause the one or more respective electronic actions associated with the designated lowest risk category to occur in relation to the portion of the POIs.

8. The device of claim 1, wherein the controller is further configured to:
recategorize, using the images received from the cameras, a given POI from a first category of the given categories to a second category of the given categories based on one or more of:
the given POI changing locations, as determined from the images; or
a monitoring status the given POI changing, as determined from the images.

9. The device of claim 1, wherein a subset of the cameras are located at access points to the given area, and the controller is further configured to:
maintain the attendee list using respective images received from the subset of the cameras indicating respective persons entering or exiting the given area via the access points.

10. The device of claim 1, wherein the controller has access to a memory storing registered images of the persons and respective locations of the cameras, and the controller is further configured to:
determine whether the POI is being monitored by the cameras by comparing the images from the cameras with the registered images; and
determine the location of the POI using a respective location, as stored at the memory, of a camera that provided an image in which the POI was detected using the registered images.

11. A method comprising:
maintaining, via a computing device, an attendee list of persons located within a given area using images received from cameras monitoring the given area;
in response to determining, via the computing device, that the given area meets a given condition:
using, via the computing device, a current version of the attendee list to generate a person-of-interest (POI) list of POIs within the given area;
categorizing, via the computing device, using the images received from the cameras, the POIs into given categories based on: whether a POI is being monitored by the cameras; whether a location associated with the POI is determined; and, the location associated with the POI, when determined; and
causing, via the computing device, one or more respective electronic actions to occur in relation to respective POIs associated with a given category into which the respective POIs are categorized.

12. The method of claim 11, further comprising:
categorizing a portion of the POIs into a designated highest risk category by determining that the portion of the POIs are not being monitored by the cameras; and
causing the one or more respective electronic actions associated with the designated highest risk category to occur in relation to the portion of the POIs.

13. The method of claim 12, wherein the one or more respective electronic actions associated with the designated highest risk category comprise initiating one or more calls to one or more communication devices associated with communication addresses registered in association with the portion of the POIs.

14. The method of claim 12, wherein the one or more respective electronic actions associated with the designated highest risk category comprise connecting one or more public-safety answering point (PSAP) calls from one or more registered communication addresses, associated with the portion of the POIs, to one or more communication devices associated with one or more first responders.

15. The method of claim 12, wherein the one or more respective electronic actions associated with the designated highest risk category comprise providing information collected during one or more public-safety answering point (PSAP) calls, from one or more registered communication addresses, associated with the portion of the POIs, to one or more communication devices associated with one or more first responders.

16. The method of claim 11, further comprising:
categorizing a portion of the POIs into a designated intermediate risk category by determining that: the portion of the POIs are being monitored by the cameras; and
respective locations of the portion of the POIs within the given area comprise designated intermediate risk locations; and
causing the one or more respective electronic actions associated with the designated intermediate risk category to occur in relation to the portion of the POIs.

17. The method of claim 11, further comprising:
categorizing a portion of the POIs into a designated lowest risk category by determining that: the portion of the POIs are being monitored by the cameras; and
respective locations of the portion of the POIs comprise designated lowest risk locations; and
causing the one or more respective electronic actions associated with the designated lowest risk category to occur in relation to the portion of the POIs.

18. The method of claim 11, further comprising:
recategorizing, using the images received from the cameras, a given POI from a first category of the given categories to a second category of the given categories based on one or more of:
the given POI changing locations, as determined from the images; or
a monitoring status the given POI changing, as determined from the images.

19. The method of claim 11, wherein a subset of the cameras are located at access points to the given area, and the method further comprises:
maintaining the attendee list using respective images received from the subset of the cameras indicating respective persons entering or exiting the given area via the access points.

20. The method of claim 11, wherein the computing device has access to a memory storing registered images of the persons and respective locations of the cameras, and the method further comprises:
determining whether the POI is being monitored by the cameras by comparing the images from the cameras with the registered images; and
determining the location of the POI using a respective location, as stored at the memory, of a camera that provided an image in which the POI was detected using the registered images.
